(19) United States
(12) Patent Application Publication
(10) Pub. No.: US 2025/0282896 A1
(43) Pub. Date: Sep. 11, 2025

(54) PROCESSES FOR PRODUCING AND REPROCESSING A RECYCLABLE ETHYLENE-VINYL ESTER POLYMER

(71) Applicant: Braskem America, Inc., Philadelphia, PA (US)

(72) Inventors: Kimberly Miller McLoughlin, Pittsburgh, PA (US); Jayme Kennedy, Pittsburgh, PA (US); Michelle K. Sing, Pittsburgh, PA (US); Sarah Matchell, Pittsburgh, PA (US)

(21) Appl. No.: 19/066,620

(22) Filed: Feb. 28, 2025

Related U.S. Application Data
(60) Provisional application No. 63/562,114, filed on Mar. 6, 2024.

(51) Int. Cl. C08F 8/14; C08J 3/12; C08L 23/26

(52) U.S. Cl. CPC C08F 8/14; C08J 3/12; C08L 23/26; C08J 2323/08; C08L 2203/14; C08L 2203/20; C08L 2207/20

(57) ABSTRACT

The present disclosure relates to a process for producing a recyclable ethylene-vinyl ester polymer, specifically, a recyclable ethylene-vinyl acetate (EVA) copolymer, comprising reacting an ethylene-vinyl acetate (EVA) polymer having an irreversibly crosslinked structure with sorbitol, via a transesterification reaction, in the presence of a transesterification catalyst, to produce a recyclable ethylene-vinyl acetate vitrimer. The present disclosure also relates to a recyclable ethylene-vinyl acetate vitrimer prepared according to said process and to a blend composition comprising the recyclable ethylene-vinyl acetate vitrimer and virgin ethylene-vinyl acetate copolymer. The present disclosure further relates to a reprocessed ethylene-vinyl acetate vitrimer, obtained by processing the recyclable ethylene-vinyl acetate vitrimer to form a processed profile, and to an article produced from the reprocessed ethylene-vinyl acetate vitrimer.

### FIELD OF THE INVENTION

This invention generally relates to processes for producing and reprocessing a recyclable ethylene-vinyl ester polymer.

### BACKGROUND OF THE INVENTION

Poly (ethylene-vinyl acetate) (EVA) is a copolymer of ethylene and vinyl acetate (VA) frequently used as a commodity plastic. The properties of EVA are mainly controlled by the VA content. In most applications, EVA is used as a crosslinked material that has been cured in the presence of a free radical initiator such as peroxide to form a three-dimensional network. Crosslinked EVA materials are used in a range of applications such as insulation materials, cables, photovoltaic modules, and shoe soles. However, crosslinked EVAs cannot typically be recycled or reused due to their high thermal and chemical stability.

One way to address the challenge of EVA recyclability involves converting the permanently crosslinked network into a covalent adaptive network (CAN). In CANs, dynamic crosslinks are incorporated into a polymer network to promote an exchange reaction that leads to topology rearrangement of the polymer network. Consequently, CANs can be reprocessed similar to thermoplastic materials without loss in mechanical properties. A new class of materials, vitrimers, has recently been proposed and which involves adopting CANs in a crosslinked polyester network using a classical transesterification reaction. The efficient exchange reactions in vitrimers allow for topological rearrangement at high temperatures and result in rapid stress relaxation while preserving network integrity. Different types of vitrimers based on dynamic chemistries such as dioxaborolane metathesis, boronic ester, vinylogous urethanes, transesterification and disulfides have been developed. Each of these chemistries relax their stress under imposed strain which indicates re-processability. Most vitrimers can be reprocessed through conventional techniques for processing thermoplastic materials, such as extrusion, melt blowing, injection molding, and compression molding.

There remains a continuing need in the art to develop new approaches to recycle crosslinked EVAs into high value-added products. This invention answers that need.

### SUMMARY

In this new approach to produce a recyclable ethylene-vinyl acetate copolymer, the inventors have focused on the presence of ester groups in the EVA networks, which allows for vitrimerization to be accomplished with a transesterification catalyst. To enable a transesterification reaction, a feedstock of hydroxyl groups is added in the reacting step. Vitrimerization of ethylene-vinyl acetate copolymer having an irreversibly crosslinked structure was then achieved by reacting ethylene-vinyl acetate copolymer having an irreversibly crosslinked structure, a transesterification catalyst, and sorbitol as the feedstock for hydroxyl groups.

Thus, one aspect of the invention relates to a process for producing a recyclable ethylene-vinyl acetate copolymer. The process comprises reacting an ethylene-vinyl acetate copolymer having an irreversibly crosslinked structure with sorbitol via a transesterification reaction in the presence of a transesterification catalyst to produce a recyclable ethylene-vinyl acetate vitrimer.

Another aspect of the invention relates to a recyclable ethylene-vinyl acetate vitrimer. The recyclable ethylene-vinyl acetate vitrimer is produced by the process described herein, i.e., a process comprising reacting an ethylene-vinyl acetate copolymer having an irreversibly crosslinked structure with sorbitol via a transesterification reaction in the presence of a transesterification catalyst.

Another aspect of the invention relates to a blend composition, comprising the recyclable ethylene-vinyl acetate vitrimer disclosed herein and a virgin ethylene-vinyl acetate copolymer having a substantially uncrosslinked structure.

Another aspect of the invention relates to a reprocessed ethylene-vinyl acetate vitrimer. The reprocessed ethylene-vinyl acetate vitrimer is produced by the process for producing a recyclable ethylene-vinyl acetate copolymer described herein, the process further comprising processing the recyclable ethylene-vinyl acetate vitrimer to form a processed profile. Another aspect of the invention relates to an article produced from the reprocessed ethylene-vinyl acetate vitrimer, wherein the article is a footwear component or product, an automotive component or product (e.g., interior or exterior automotive components, such as instrument panel skins and door panel skins; pumpers), a packaging material, a furniture product, a building material (e.g., roofing membranes and thermal and sound insulation), a textile product (e.g., nonwoven fabrics and fibers), a sports/recreation product, or a consumer electronic product.

Another aspect of the invention relates to a foam. The foam may be produced by the process for producing a recyclable ethylene-vinyl acetate copolymer described herein, the process further comprising processing the recyclable ethylene-vinyl acetate vitrimer to form a processed profile, wherein the processing step comprises foaming.

### BRIEF DESCRIPTION OF DRAWINGS

FIG. 1 shows a comparison of DMA results for a vitrimer obtained using sorbitol and PVOH, both grinding via cryomilling.

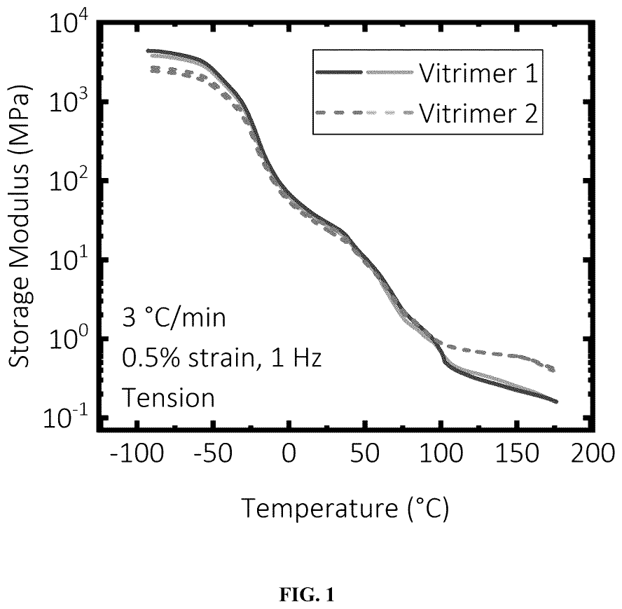

FIG. 2 shows a comparison of DMA results for a vitrimer obtained using PVOH, ground via cryomilling, and the reprocessed version of this same vitrimer.

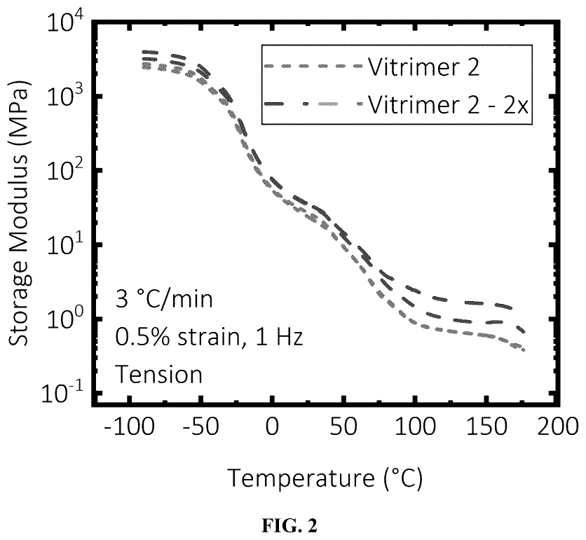

FIG. 3 shows a comparison of DMA results for a vitrimer obtained using sorbitol, ground via cryomilling, and the reprocessed version of this same vitrimer.

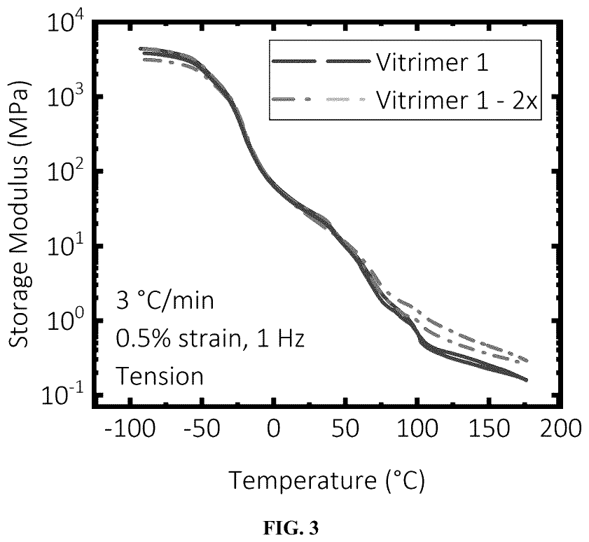

FIG. 4 shows a comparison of DMA results for a vitrimer obtained using sorbitol, ground via cryomilling, and non-cryogenic grinding.

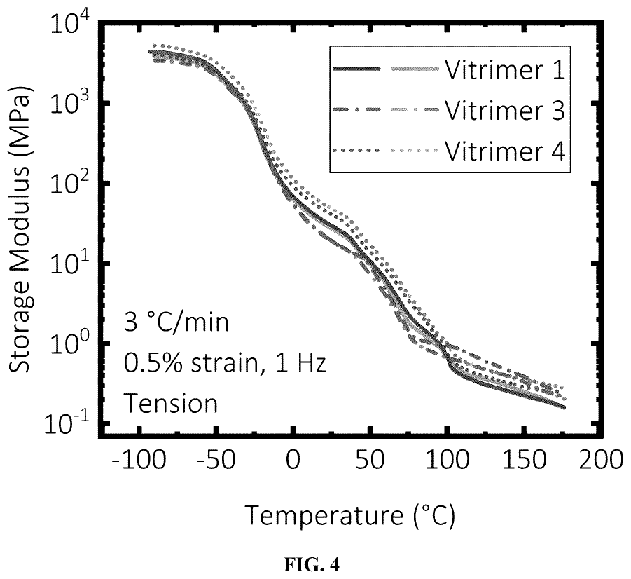

### DETAILED DESCRIPTION

In a first aspect, embodiments disclosed herein relate to a process for producing a recyclable ethylene-vinyl ester polymer, more specifically an ethylene-vinyl acetate copolymer, comprising: reacting an ethylene-vinyl ester polymer having an irreversibly crosslinked structure with sorbitol, via a transesterification reaction, in the presence of a transesterification catalyst, to produce a recyclable ethylene-vinyl ester vitrimer. More preferably, the recyclable ethylene-vinyl ester according to the present invention is an ethylene-vinyl acetate copolymer.

In one or more embodiments, the process further comprises, prior to the reacting step: grinding the ethylene-vinyl ester polymer into fine powders in the absence of the transesterification catalyst.

In one or more embodiments, the fine powders have an average particle size of less than or equal to 1000 μm, such as less than or equal to 750 μm, less than or equal to 500 μm, or less than or equal to 300 μm.

In one or more embodiments, the grinding step is carried out at a temperature above liquid nitrogen temperature, for instance at a temperature above −50° C., such as a temperature above −25° C., a temperature above −15° C., a temperature above 0° C., or at an ambient temperature.

In one or more embodiments, the process is carried out in the absence of a cryomilling step.

In one or more embodiments, the ethylene-vinyl ester polymer is obtained from a recycled material, optionally wherein the recycled material is a post-consumer resin (PCR), post-industrial resin (PIR), or combinations thereof.

In one or more embodiments, the vinyl ester in the ethylene-vinyl ester polymer is an aliphatic vinyl ester having 3 to 20 carbon atoms or an aromatic vinyl ester.

In one or more embodiments, the ethylene-vinyl ester polymer is an ethylene-vinyl acetate (EVA) copolymer.

In one or more embodiments, the transesterification catalyst is a zinc salt catalyst. In one or more embodiments, the transesterification catalyst is a transitional metal acetate catalyst.

In one or more embodiments, the transesterification catalyst is zinc acetate. In one or more embodiments, the amount of zinc acetate ranges from about 0.1 mol % to about 20 mol %, such as from about 5 mol % to about 10 mol %, relative to 100 mol % of the vinyl acetate (VA) content in the EVA copolymer.

In one or more embodiments, the molar ratio of hydroxyl groups in sorbitol to vinyl acetate (VA) in the EVA copolymer ranges from about 1 to about 5, such as from about 1 to about 2.

In one or more embodiments, the reacting step is carried out at a temperature higher than the melting temperature of sorbitol; for instance, at a temperature higher than about 97° C., such as a temperature higher than about 100° C., higher than about 120° C., higher than about 150° C., higher than about 180° C., or higher than about 200° C.

In one or more embodiments, the reacting step is carried out in a melt-mixer, extruder, intermeshing mixer, kneader mixer or any combination thereof.

In one or more embodiments, the produced recyclable ethylene-vinyl ester vitrimer contains a covalent adaptive network formed by dynamic, reversibly crosslinked structure that allows the recyclable ethylene vinyl ester vitrimer to be reprocessed at a temperature of 120° C. or higher (for instance, to be reprocessed at a temperature of 120° C. or higher, at least two times higher, or at least three times higher), without adding further reactants and/or catalysts.

In one or more embodiments, the process further comprises processing the recyclable ethylene-vinyl ester vitrimer to form a processed profile, wherein the processing step optionally comprises extrusion, melt blowing, molding, pelletizing, fiber spinning, foaming, or combinations thereof.

In one or more embodiments, the processing step comprises extruding the recyclable ethylene-vinyl ester vitrimer at a temperature of 120° C. or higher.

In one or more embodiments, the processing step comprises compression molding the recyclable ethylene-vinyl ester vitrimer at a temperature of 175° C. or higher.

In one or more embodiments, the processing step comprises foaming the recyclable ethylene-vinyl ester vitrimer, optionally in the presence of a foaming agent.

In a second aspect, embodiments disclosed herein relate to a recyclable ethylene-vinyl ester vitrimer, prepared according to the process for producing a recyclable ethylene-vinyl ester polymer of the present disclosure.

In a third aspect, embodiments disclosed herein relate to a blend composition, comprising the recyclable ethylene-vinyl ester vitrimer of the present disclosure, and a virgin ethylene-vinyl ester polymer having a substantially uncrosslinked structure.

In a fourth aspect, embodiments disclosed herein relate to a reprocessed ethylene-vinyl ester vitrimer, prepared according to the process of the present disclosure. The reprocessed ethylene-vinyl ester vitrimer is produced by the process for producing a recyclable ethylene-vinyl ester polymer described herein, the process further comprising processing the recyclable ethylene-vinyl ester vitrimer to form a processed profile.

In a fifth aspect, embodiments disclosed herein relate to an article produced from the reprocessed ethylene-vinyl ester vitrimer of the present disclosure, wherein the article is a footwear component or product, an automotive component or product (e.g., interior or exterior automotive components, such as instrument panel skins and door panel skins; pumpers), a packaging material, a furniture product, a building material (e.g., roofing membranes and thermal and sound insulation), a textile product (e.g., nonwoven fabrics and fibers), a sports/recreation product, or a consumer electronic product.

In a sixth aspect, embodiments disclosed herein relate to a foam. The foam is produced by the process for producing a recyclable ethylene-vinyl ester polymer described herein, the process further comprising processing the recyclable ethylene-vinyl ester vitrimer to form a processed profile, wherein the processing step comprises foaming. In one or more embodiments, the foam optionally comprising at least 10% wt., such as at least 30% wt., at least 50% wt., or at least 70% wt. of the recyclable ethylene-vinyl ester vitrimer of the present disclosure.

### EXAMPLES

The following examples are for illustrative purposes only and are not intended to limit, in any way, the scope of the present invention.

### Materials and Methods

### Materials

EVA foam waste was supplied by brand owners from footwear manufacturing processes. The waste was received in the form of manufacturing scrap, which varied in size and shape and included parts as large as a full shoe midsole.

Polyvinyl alcohol PVOH (average Mw 130,000 g/mol), sorbitol, zinc acetate, and dicumyl peroxide (DCP) were purchased from Sigma-Aldrich and used as received.

A first set of examples compares the effect of using sorbitol versus polyvinyl alcohol.

### Examples 1 and 2

Pre-grinding: EVA foam waste was first ground to provide particles with average diameter 1 mm or less, as measured by sieves. A SPEX freezer mill was used for the grinding.

Cryomilling EVA with Catalyst: The EVA foam waste particles were then dry blended with zinc acetate and a solid alcohol, and the mixture was ground in a cryogenic mill to provide a mixture with average particle size 750 microns. In a first example, (Vitrimer 1) the solid alcohol was sorbitol. In a second example (Vitrimer 2) the solid alcohol was polyvinyl alcohol (PVOH.) Feed concentrations of zinc acetate and alcohol are shown in Table I below.

Melt-mixing: The mixture of EVA waste particles, zinc acetate, and alcohol were melt-mixed in a co-rotating, twin screw, micro compounding extruder operating at 120° C. with a screw speed of 100 rpm. The mixture was fed to the throat, passed through the extruder, and extruded directly through the die with no re-circulation. The extrudate was collected and passed through the extruder for a second time.

Compression molding: The extruded strands were then cut into pieces of 3-5 mm length and then placed in a rectangular mold with area 4.9 cm² and thickness 1 mm. Samples were preheated with no applied pressure for 5 minutes, then held at 13.5 MPa (2-4 ton) pressure for 10 minutes. Vitrimer 1 was compression molded using a press temperature of 100° C., and Vitrimer 2 was compression molded using a press temperature of 175° C.

Reprocessing: To test the effect of reprocessing, compression molded samples prepared as above were cut into small pieces (3 to 5 mm) and compression molded again under the same processing conditions. The reprocessed samples are labeled in the Figures as Vitrimer 1-2× and Vitrimer 2-2×, to indicate that the sample has been compression molded two times.

The following examples demonstrate the inventive process, in which the EVA foam waste is ground in the absence of any transesterification catalyst. In a subsequent step, the EVA was vitrimerized by melt-mixing the ground EVA scrap with zinc acetate and sorbitol at a temperature higher than the melting temperature of the sorbitol.

### Example 3: Melt-Mixing in Kneader Mixer

Pre-grinding: EVA foam waste was fed into the hopper of a twin-screw extruder operating at 10 rpm with barrel set temperatures at 150° C. The extrudate was in the form of a ground fluff mixed with some discreet ground particles.

Melt-mixing EVA with Catalyst: The EVA foam waste fluff was dry blended with zinc acetate and a sorbitol, and the mixture was fed directly to a kneader mixer and melt-mixed for approximately 10 minutes, until the thermocouples on the equipment indicated that the mixture had reached a temperature of 150° C. The mixture was removed from the mixer, passed through a two-roll mill to provide a continuous sheet, and cooled.

Compression molding: Samples weighing 1-2 grams were cut from the continuous sheets and were compression molded using the procedure described above. (rectangular mold with area 4.9 cm² and thickness 1 mm. Samples were preheated at 100° C. with no applied pressure for 5 minutes, then held at 13.5 MPa (2-4 ton) pressure for 10 minutes.)

Reprocessing: To test the effect of reprocessing, compression molded samples were cut into small pieces (3 to 5 mm) and compression molded again under the same processing conditions. The reprocessed sample is labeled in the Figures as Vitrimer 3-2×, to indicate that this sample has been compression molded two times.

### Example 4

Pre-grinding: EVA foam waste was first ground to provide particles with average diameter 1 mm or less, as measured by sieves. A SPEX freezer mill was used for the grinding.

Cryomilling EVA in the Absence of Catalyst: The EVA foam waste particles were ground in a cryogenic mill to provide a mixture with average particle size 750 microns.

Melt-mixing: Ground EVA waste particles were melt-mixed with zinc acetate and sorbitol in a co-rotating, twin screw, micro compounding extruder operating at 120° C. with a screw speed of 100 rpm. The mixture of ground EVA, zinc acetate, and sorbitol was fed to the throat and extruded for 8 minutes with re-circulation. The die was then opened, and extruded strands were collected. The extruded strands were cut into pieces of 3-5 mm length and then placed in a rectangular mold with area 4.9 cm² and thickness 1 mm.

Compression molding: Samples were preheated at 100° C. with no applied pressure for 5 minutes, then held at 13.5 MPa (2-4 ton) pressure for 10 minutes.

Reprocessing: To test the effect of reprocessing, compression molded samples prepared as above were cut into small pieces (3 to 5 mm) and compression molded again under the same processing conditions. The reprocessed sample is labeled in the Figures as Vitrimer 4-2×, to indicate that this sample has been compression molded two times.

### Characterization

Dynamic Mechanical Analysis (DMA): The dynamic mechanical properties were measured by TA Instruments Q800. The tensile mode with a strain amplitude of 0.5% and constant frequency of 1 Hz was used for the measurement. Temperature was increased with a scanning rate of 5° C. min⁻¹ from −55 to 200° C.

TABLE 1
Formulations and Processes for Vitrimerization

| Sample | | Grinding | Reaction | Wt % zinc | Wt % |
|---|---|---|---|---|---|
| Name | Alcohol | Process | process | acetate | alcohol |
| Vitrimer 1 | Sorbitol | Cryomilling | Cryomilling | 1.4 | 5.4 |
| | | | EVA + catalyst | | |
| Vitrimer 2 | PVOH | Cryomilling | Cryomilling | 1.7 | 7.7 |
| | | | EVA + catalyst | | |
| Vitrimer 3 | Sorbitol | Non- | Melt-mixing | 1.6 | 5.4 |
| | | Cryogenic | EVA + catalyst | | |
| | | grinding | | | |
| Vitrimer 4 | Sorbitol | Cryomilling | Melt-mixing | 1.5 | 5.4 |
| | | | EVA + catalyst | | |

What is claimed is:

1. A process for producing a recyclable ethylene-vinyl acetate vitrimer, comprising:
reacting (a) an ethylene-vinyl acetate (EVA) copolymer having an irreversibly crosslinked structure with (b) sorbitol, via a transesterification reaction, in the presence of a transesterification catalyst, to produce a recyclable ethylene-vinyl acetate vitrimer.

2. The process of claim 1, further comprising, prior to the reacting step:
grinding the ethylene-vinyl acetate copolymer into fine powders in the absence of the transesterification catalyst.

3. The process of claim 2, wherein the fine powders have an average particle size of less than or equal to 1000 μm.

4. The process of claim 2, wherein the grinding step is carried out at a temperature above −50° C.

5. The process of claim 1, wherein the process is carried out in the absence of a cryomilling step.

6. The process of claim 1, wherein the ethylene-vinyl acetate vitrimer is obtained from a recycled material, wherein the recycled material is a post-consumer resin (PCR), post-industrial resin (PIR), or combinations thereof.

7. The process of claim 1, wherein the vinyl ester in the ethylene-vinyl acetate copolymer is an aliphatic vinyl ester having 3 to 20 carbon atoms or an aromatic vinyl ester.

8. The process of claim 7, wherein the transesterification catalyst is a zinc salt catalyst.

9. The process of claim 7, wherein the transesterification catalyst is a transitional metal acetate catalyst.

10. The process of claim 8, wherein the transesterification catalyst is zinc acetate, wherein the amount of zinc acetate ranges from about 0.1 mol % to about 20 mol %, relative to 100 mol % of the vinyl acetate (VA) content in the EVA copolymer.

11. The process of claim 8, wherein the molar ratio of hydroxyl groups in sorbitol to vinyl acetate (VA) in the EVA copolymer ranges from about 1 to about 5.

12. The process of claim 1, wherein the reacting step is carried out at a temperature higher than about 97° C.

13. The process of claim 1, wherein the reacting step is carried out in a melt-mixer, extruder, intermeshing mixer, kneader mixer or any combination thereof.

14. The process of claim 1, wherein the produced recyclable ethylene-vinyl acetate vitrimer contains a covalent adaptive network formed by dynamic, reversibly crosslinked structure that allows the recyclable ethylene vinyl acetate vitrimer to be reprocessed at a temperature of 120° C. or higher, without adding further reactants and/or catalysts.

15. The process of claim 1, further comprising:
processing the recyclable ethylene-vinyl acetate vitrimer to form a processed profile, wherein the processing step comprises extrusion, melt blowing, molding, pelletizing, fiber spinning, foaming, or combinations thereof.

16. The process of claim 15, wherein the processing step comprises extruding the recyclable ethylene-vinyl acetate vitrimer at a temperature of 120° C. or higher.

17. The process of claim 15, wherein the processing step comprises compression molding the recyclable ethylene-vinyl acetate vitrimer at a temperature of 175° C. or higher.

18. The process of claim 15, wherein the processing step comprises foaming the recyclable ethylene-vinyl acetate vitrimer in the presence of a foaming agent.

19. A recyclable ethylene-vinyl ester vitrimer, prepared according to the process of claim 1.

20. A blend composition, comprising:
the recyclable ethylene-vinyl acetate vitrimer of claim 19, and
a virgin ethylene-vinyl acetate polymer having a substantially uncrosslinked structure.

21. A reprocessed ethylene-vinyl acetate vitrimer, prepared according to the process of claim 15.

22. An article produced from the reprocessed ethylene-vinyl acetate vitrimer of claim 21, wherein the article is a footwear component or product, an automotive component or product, a packaging material, a furniture product, a building material, a textile product, a sports/recreation product, or a consumer electronic product.

23. A foam produced according to the process of claim 18, comprising at least 10% wt. of the recyclable ethylene-vinyl acetate vitrimer.
